(19) United States
(12) Patent Application Publication
(10) Pub. No.: US 2005/0091105 A1
(43) Pub. Date: Apr. 28, 2005

(54) Business card display

(76) Inventor: Jody L. Novak-Torre, Hope, NJ (US)

Correspondence Address: PHARMACEUTICAL PATENT ATTORNEYS, LLC, 55 MADISON AVENUE, 4TH FLOOR, MORRISTOWN, NJ, 07960-7397, US

(21) Appl. No.: 10/693,472

(22) Filed: Oct. 23, 2003

(51) Int. Cl. G06F 17/60

(52) U.S. Cl. 705/14

(57) ABSTRACT

An advertising kiosk combining a business card display rack and an electronic screen which displays advertising for the advertisers having business cards in the display rack.

### BACKGROUND

I am an advertising and marketing professional; I have worked in the field for many years. Over the course of my professional work, I have seen a long-standing problem with a certain kind of local advertising technology, and have now invented a solution to make it better.

Businesses often have business card display racks in, for example, their reception area. These displays are good to provide advertising to potential customers who physically visit the business, but are ineffective to provide advertising to potential new customers who are not physically at the business.

Thus, the art teaches using business card display racks in third party locations, to provide advertising cards to potential new customers. Thus, for example, diners and similar restaurants often have near the entrance a business card display rack which displays not the restaurant's own business cards, but advertising cards for other local businesses (e.g., the local plumber, the local real estate agent). Similarly, restaurants occasionally have near the bathrooms, a rack displaying free advertising postcards.

These display racks have the advantage of enabling the advertiser (the local plumber, for example) to advertise to potential customers who do not physically visit the advertiser's own place of business. A disadvantage of these display racks, however, is that they can be overlooked in the busy atmosphere of a restaurant. Another disadvantage is that they only provide advertising information as printed material, and thus lack the cogency and communication power of multimedia.

Another disadvantage is that they lack the capability to finely tailor a particular advertiser's exposure time. That is to say, a specific advertiser either has their material in the display rack, or they do not; it would be difficult or impossible to modify display time among advertisers. For example, assume two advertisers have two different budgets—one is a high-paying advertiser, willing to pay for 24-hour exposure, the other a limited-budget advertiser only willing to pay for exposure during the midday lunchtime rush. A conventional display rack makes no provision for giving one advertiser more time during the day, or less; the lower-budget advertiser either has their materials in the display rack, or does not.

### BRIEF DESCRIPTION

I have found a way to resolve these problems. My invention entails combining a conventional display rack with an electronic display—an electronic billboard, if you will. The electronic display is connected to a wide area network, so that advertising media (e.g., short commercials for the advertisers who have their cards displayed in the rack) may be transferred from a central server to a specific electronic display, and the central server can schedule which advertising message is displayed when, for how long, and on how many electronic displays.

### BRIEF DESCRIPTION OF THE FIGURES

FIG. 1 shows an isometric view of my preferred embodiment of my invention.

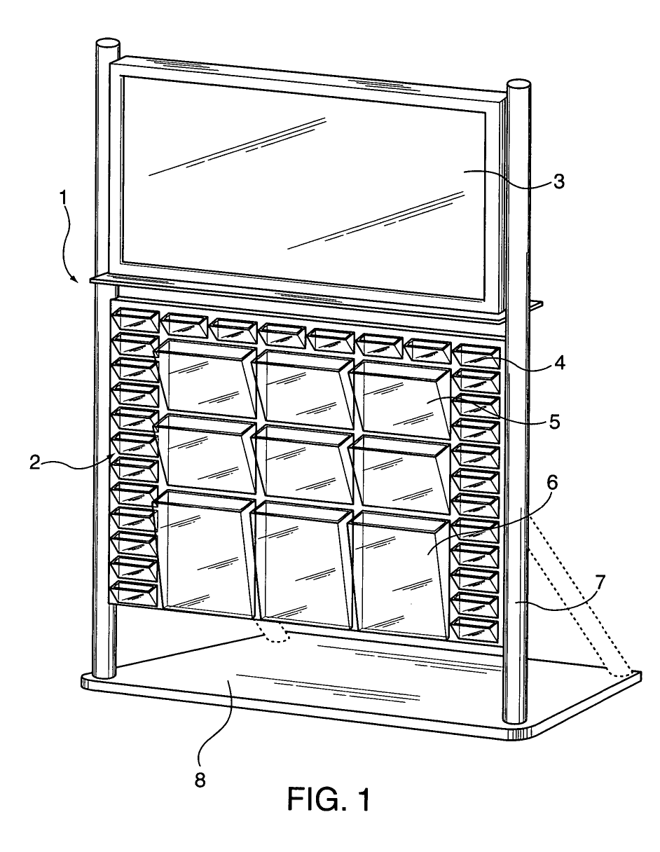

FIG. 2 shows my preferred embodiment of my invention from a front view.

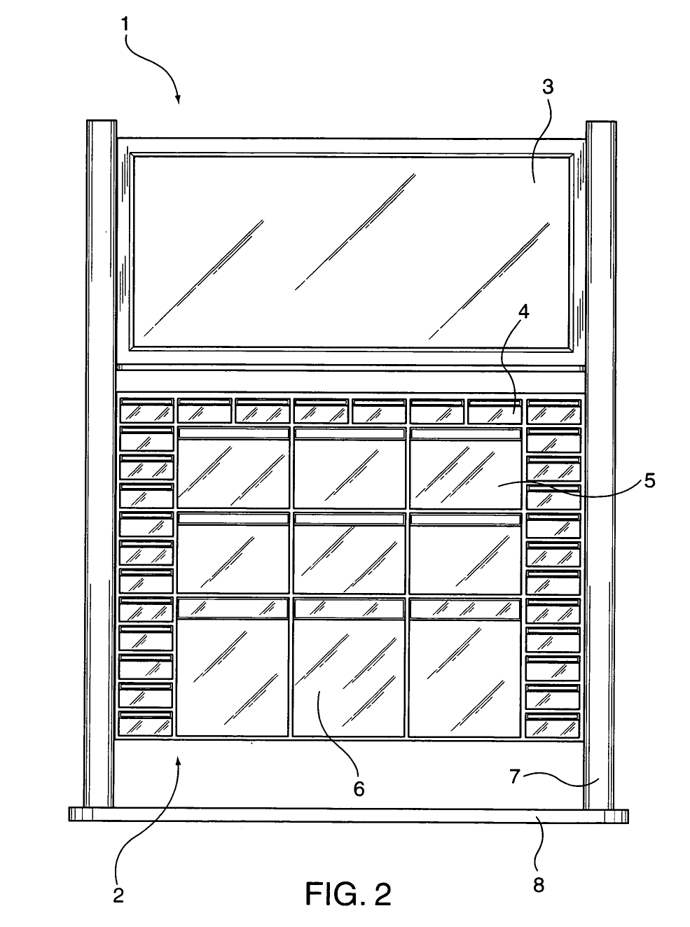

FIG. 3 shows my preferred embodiment of my invention from a rear view.

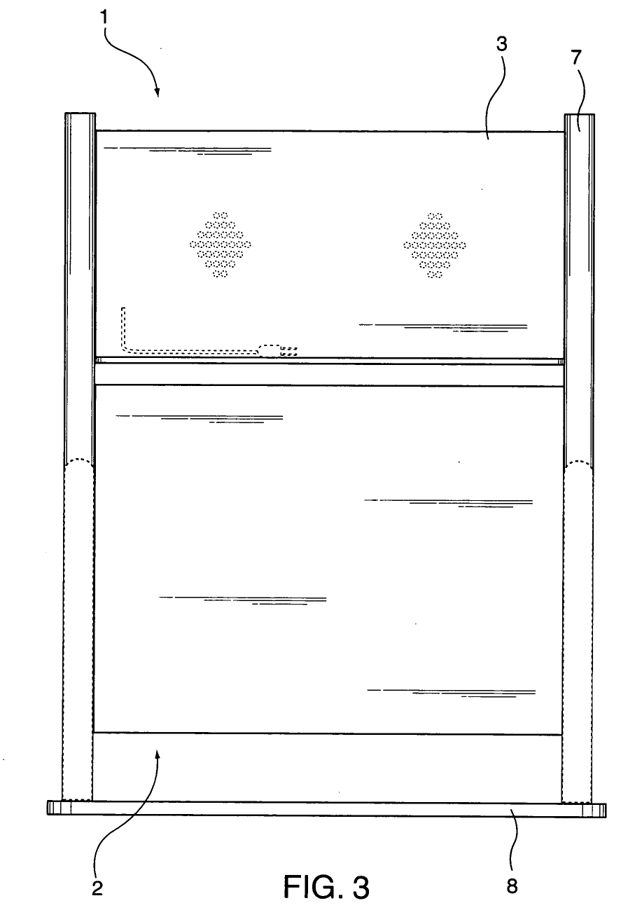

FIGS. 4 and 5 show my preferred embodiment of my invention from a left side and right side view.

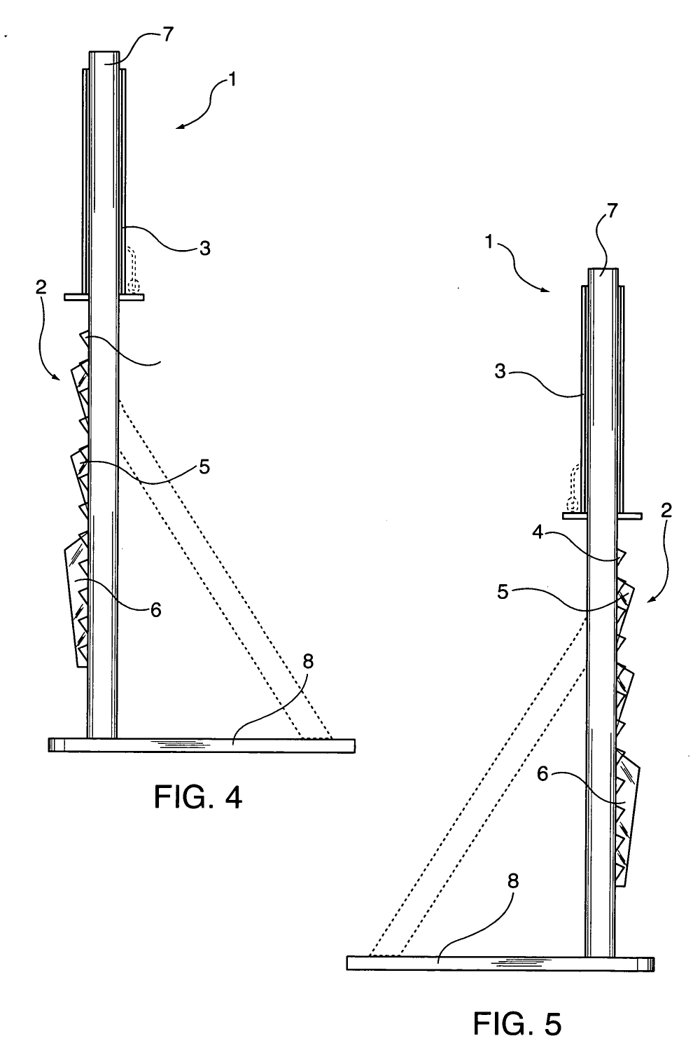

FIGS. 6 and 7 show my preferred embodiment of my invention from a top and bottom view.

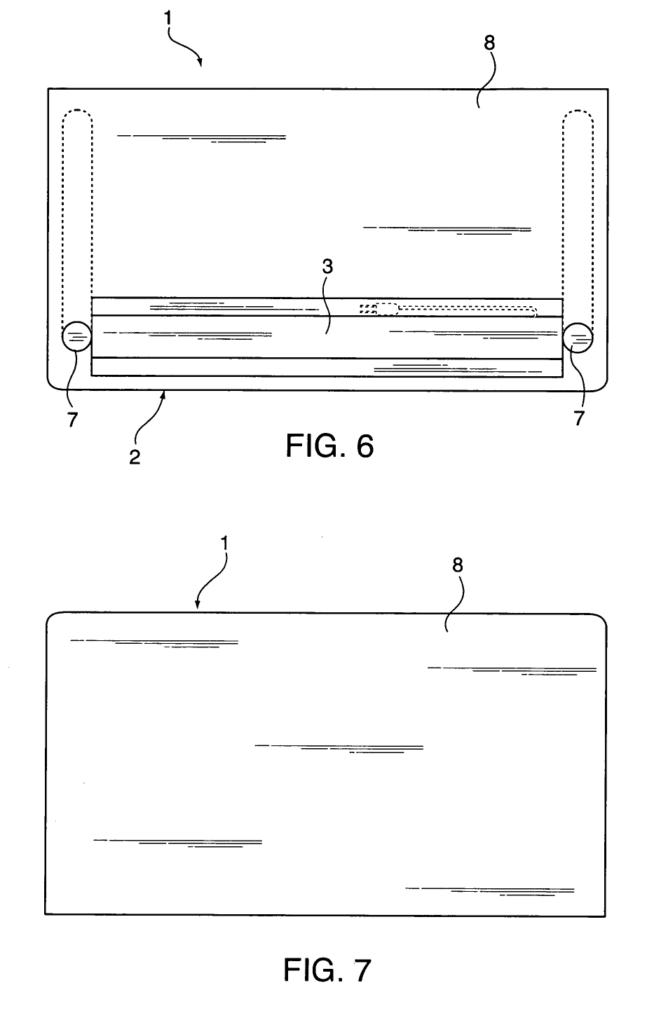

FIG. 8 provides a schematic representation of a wide area computer network suitable for transferring advertising media information to each of a plurality of display devices.

### DETAILED DESCRIPTION

My invention [1] includes several elements: a business card display rack [2], an electronic display [3], advertising media and a server. I will discuss each in turn.

Business Card Display Rack

The fist component of my invention [1] is a business card display rack [2]. The business card display rack is a rack that is configured to display a plurality of business-card-size [4] or other size (e.g., postcard size [5], tri-fold brochure size [6] advertising or promotional handouts. I prefer the configuration shown in the accompanying figures, albeit one can easily derive other configurations as suitable.

The most important feature is that the business card display rack [2] enable the potential customer to locate and retrieve specific hard copy advertising from the specific advertiser they are interested in. Thus, for example, if the potential customer is interested in the local plumber (and not interested in the local real estate agent), then the display rack [2] must array the hard copy promotional material such that the potential customer can find, among all the promotional material provided, the promotional material relating to the plumber. In contrast, a bin into which is put a random collection of promotional handouts from a random collection of advertisers would not be terribly productive.

And note, while I use the term “business card” display rack in the claims, I specifically intend this phrase to encompass not simply cards sized approximately 2½″×3″; to the contrary, I intend this claim term to mean any sized promotional handout, be it business card size, postcard size, or some other desirable size.

The Electronic Display

The business card display rack [2] is provided with an electronic display [3]. The electronic display [3] can be a flat-screen computer monitor, liquid crystal display, or other display device. The electronic display [3] may be physically connected to the display rack [2] by a frame [7] with a base [8], albeit this is not necessary; it suffices to have each in visual proximity to the other.

The electronic display [3] must be able to accept the electronic advertising media as discussed below; thus, the electronic display [3] must be in communication with a communication device (a modem, a codec, a “cable modem” or Ethernet card, etc . . . ) able to accept the advertising media when transmitted from the server (discussed below) electronically over a wide area network. This is shown in the Figures as a dashed cable; hard-wiring is not essential as, for example, WIFI or wireless internet may be used.

The electronic display [3] must of course be able to display the electronic advertising media discussed below (e.g., streaming media); thus, depending on the nature of the advertising media, the electronic display [3] may need to concomitantly include a computer central processing unit, a video or media card, an operating system, media-reproduction software, etc . . . Such computer hardware is known in the art (a standard laptop computer comes with all of this), and thus need not be discussed further.

It may optionally have the capacity to play sound, but this is not essential.

The Advertising Media

The electronic display displays advertising media. That is, commercials for the advertisers who have their hard-copy promotional materials displayed in the display rack discussed above. Thus, to continue our example, where the local plumber and local real estate agent have purchased advertising space, then the display rack contains hard-copy promotional materials for each of the plumber and the real estate agent, and the electronic display displays commercials for each of the plumber and the real estate agent.

These commercials could be moving-image advertisements (such as seen on television), or still images (simply a still image of the advertiser's hard-copy promotional materials contained in the display rack, for example), or whatever else the advertiser prefers to use.

By showing advertising on the electronic display, and providing at that same location a physical hard-copy promotional item, I believe that the advertising campaign will achieve synergies over what either component could achieve alone. That is, hard-copy promotional items have some physical permanence with the potential customer, yet lack a certain emotional cogency. Broadcast advertising, in contrast, achieves that emotional cogency yet, because it is broadcast, is short-lived and lacks the physical permanence of a hard-copy promotional item. By providing both at the same location, the advertiser is able to effect the emotional cogency of a broadcast advertisement, and then psychologically anchor that emotional cogency with a tangible hard-copy promotional piece which preserves that emotional cogency over time. Thus, by providing the two in the same location and time, I believe the advertising campaign will achieve results synergistic to what either one alone would generate.

The Server

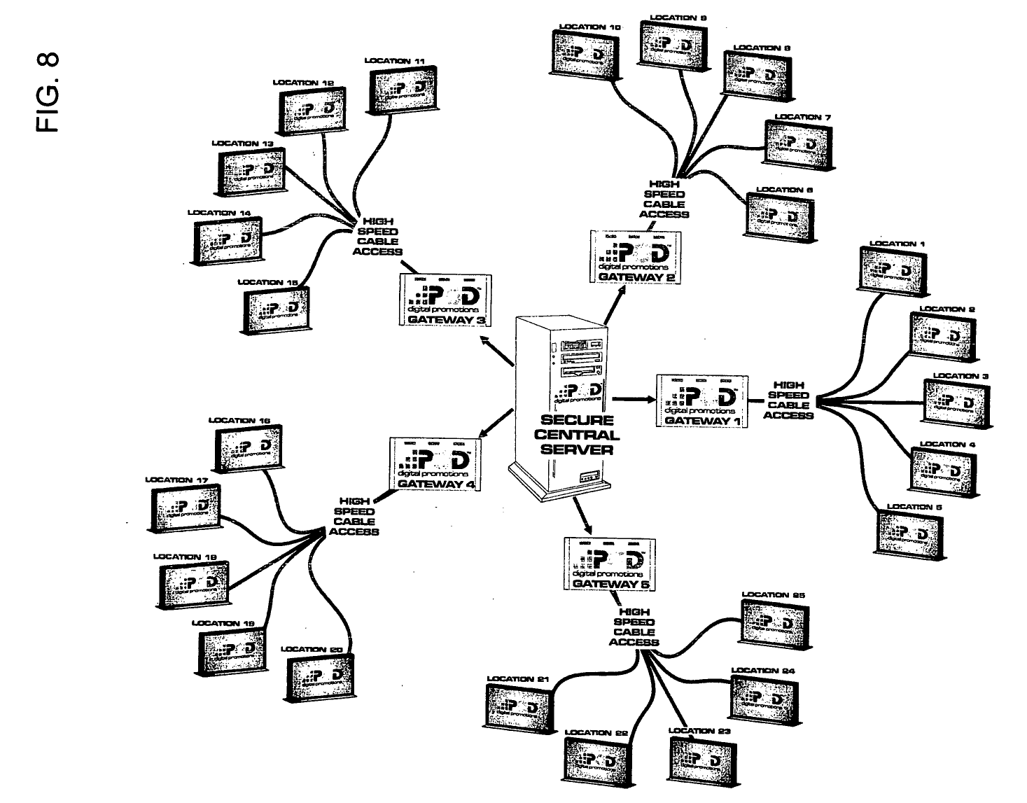

Conceivably, one could make a stand-alone kiosk using just the forgoing three components; this would achieve the functional synergy discussed above. While this works well for one kiosk, what of a plurality of kiosks? One can improve the operating efficiency of a plurality of kiosks by connecting them via a wide area network and using a central server (shown as a “Secure Central Server” in FIG. 8) to serve advertising media to, and thus, control, each electronic display.

Server technology and the requisites for a server to transfer media to a host display are known in the art. I focus, then, on particular features that I find important.

The server can control what media is displayed on which electronic display(ies) from a plurality of electronic displays (shown as Location 1 through Location 25 on FIG. 8). Thus, for example, if our two advertisers include the local plumber and the real estate agent who works with a nation-wide real estate brokerage, then the server can display the local plumber's electronic advertisement only on the electronic display located physically proximate to the plumber's place of business; the same server can, in contrast, serve the real estate broker advertising media to all electronic displays in the entire system, across the country.

The server can control when the advertising media is displayed. The server can display the local plumber's media every thirty minutes, for example, while the real estate agent—realizing that most home shopping happens on the weekends—may choose to have his ad displayed every ten minutes, but only from Friday afternoon through Sunday morning.

Controlling the number and location of the electronic displays, and the frequency and timing of the advertising media, enables the system administrator (the advertising agency) to precisely tailor advertising campaigns to meet advertiser objectives and budget constraints. Scheduling means are known in the art of computer programming and need not be discussed further.

### SUMMARY

While I have described my preferred embodiment in some detail, my invention is not limited to this specific version; rather, other variations may become apparent to those of skill in the art of marketing and advertising. For example, while I discuss an apparatus that includes a rack [2] to display printed advertising materials in some detail, such a rack may not be necessary; rather, one might make an advertising system with the server and electronic displays, yet without the rack nor the hard-copy advertising handouts at all. Thus, I intend the scope of my patent to be defined not by the specific examples discussed above, but by the claims appended below.

On a similar vein, I discuss business cards and restaurants to make the general concept of my invention understandable. I believe, however, that my invention will have particular usefulness in advertising dental, pharmaceutical, dermatology and other medical products, when the display is used in a health care provider's office (e.g., a dentist's office) and the hard-copy advertising materials relate to specific products or services (e.g., teeth bleaching products, cosmetic dentistry services).

In the claims, the word “a” allows for one or more than one of the specified element (for example, “a display” means at least one display, but possible more). I intend the claims to be read as a whole; accordingly, I intend the preamble of the claim to limit the scope of the claim.

1. An advertising method comprising:
providing a business card display rack;
displaying on said rack a plurality of hard-copy promotional items;
providing in visual proximity to said rack an electronic display;
serving advertising media from a server to said electronic display; and
displaying on said electronic display said advertising media.

2. The advertising method of claim 1, said advertising media displayed on said electronic display pursuant to a display schedule determined by said server.

3. The advertising method of claim 2, further comprising:
charging an advertiser based on said display schedule.

4. An advertising system comprising:
a business card display rack;
displayed on said rack a plurality of hard-copy promotional items;
displayed in visual proximity to said rack an electronic display; and
advertising media served from a server to said electronic display and displayed on said electronic display.

5. The advertising system of claim 4, said advertising media displayed on said electronic display pursuant to a display schedule determined by said server.

6. The advertising system of claim 5, further comprising:
means to charge an advertiser based on said display schedule.

7. An article of manufacture comprising:
a business card display rack;
displayed on said rack a plurality of hard-copy promotional items;
accompanying said rack an electronic display; and
a server in communication with said electronic display,
said server storing advertising media displayable on said electronic display.

8. The advertising article of manufacture of claim 7, said advertising media displayed on said electronic display pursuant to a display schedule determined by said server.

9. The advertising article of manufacture of claim 8, further comprising:
means to charge an advertiser based on said display schedule.

10. The advertising article of manufacture of claim 9, further comprising:
G. a vertical frame mounting said electronic display substantially above said display rack.

11. The advertising method of claim 1, further comprising:
providing a second electronic display in visual proximity to said rack;
serving said advertising media to said second electronic display; and
displaying on said second electronic display said advertising media.

12. The advertising system of claim 4, further comprising:
a second electronic display provided in visual proximity to said rack, wherein the advertising media is served from the server to said second electronic display and displayed on said second electronic display.

13. The advertising article of manufacture of claim 7, further comprising:
a second electronic display accompanying said rack, wherein the advertising media is displayable on said second electronic display.
